(19) United States
(12) Patent Application Publication
(10) Pub. No.: US 2012/0036691 A1
(43) Pub. Date: Feb. 16, 2012

(54) BEARING MOUNTING AND DISMOUNTING TOOL

(75) Inventor: MICHAEL MUELLER, BAD STAFFELSDEIN (DE)

(73) Assignee: MUELLER-KUEPS, L.P., TUCKER, GA (US)

(21) Appl. No.: 12/855,943

(22) Filed: Aug. 13, 2010

(51) Int. Cl. B25B 27/073

(52) U.S. Cl. 29/263

(57) ABSTRACT

A bearing mounting and dismounting tool for mounting/dismounting a bearing in a mounting hole of a mechanical component includes: a first pipe having an internal diameter greater than an external diameter of the bearing, and an external diameter of the first pipe greater than a hole diameter of the mounting hole; a second pipe, coaxially aligned with the first pipe, and having an external diameter smaller than an internal diameter of the first pipe, and abuttable against a distal surface of the bearing; and an operating module for providing an action force to change relative positions of the first and second pipes; such that the first pipe is abutted against a peripheral wall of the mounting hole installed with the bearing, and the second pipe is abutted against the bearing, and the operating module changes the relative positions of the first and second pipes to mount/dismount the bearing.

### BACKGROUND OF THE INVENTION

1. Field of the Invention

The present invention relates to a tool, and more particularly to a bearing mounting and dismounting tool.

2. Description of the Related Art

Conventionally, a bearing is mounted onto a mechanical component or removed from a mechanical component generally by hammering the bearing, but the hammering method not only damages the mechanical component or the bearing easily, but also incurs a risk of injuring an operator accidentally.

In view of the foregoing drawback of the prior art, the inventor of the present invention conducted extensive researches and experiments, and finally invented a bearing mounting and dismounting tool in accordance with the present invention.

### SUMMARY OF THE INVENTION

Therefore, it is a primary objective of the invention to provide a bearing mounting and dismounting tool with the effect of facilitating an operator to mount or dismount a bearing.

To achieve the foregoing objectives, the present invention provides a bearing mounting and dismounting tool for mounting or dismounting a bearing at a mounting hole of a mechanical component, and the bearing mounting and dismounting tool comprises:

a first pipe, having an internal diameter greater than an external diameter of the bearing, and an external diameter of the first pipe greater than a hole diameter of the mounting hole;

a second pipe, coaxially aligned with the first pipe, and having an external diameter smaller than an internal diameter of the first pipe, and abuttable against a distal surface of the bearing;

an operating module, including two discs abutted against the first and second pipes respectively, and the two discs having a plurality of abutting surfaces with different widths and in a continuous stairway shape disposed at positions of abutting the distal surfaces of the discs, and a screw rod being coaxially passed through the first and second pipes, and both ends of the screw rod being passed through and out of the discs respectively, and both ends of the screw rod passed out from each disc being screwed with a screw thread insert for forcing the two discs to move the first and second pipes;

such that the first pipe can be installed onto a peripheral wall of a mounting hole of a mechanical component that is installed with the bearing, and the second pipe can be abutted against the distal surface of the bearing installed in the mounting hole, and the screw thread insert of the operating module can be rotated to change the relative positions of the first and second pipes in order to mount or dismount the bearing.

### BRIEF DESCRIPTION OF THE DRAWINGS

FIG. 1 is an exploded view of a preferred embodiment of the present invention;

FIG. 2 is a schematic view of an application of a preferred embodiment of the present invention, showing that a first pipe is abutted against a peripheral wall of a mounting hole and a second pipe is abutted from another side against a distal surface of a bearing installed in the mounting hole; and

FIG. 3 is a schematic view of an application of a preferred embodiment of the present invention, showing that a bearing is being dismounted.

### DETAILED DESCRIPTION OF THE PREFERRED EMBODIMENTS

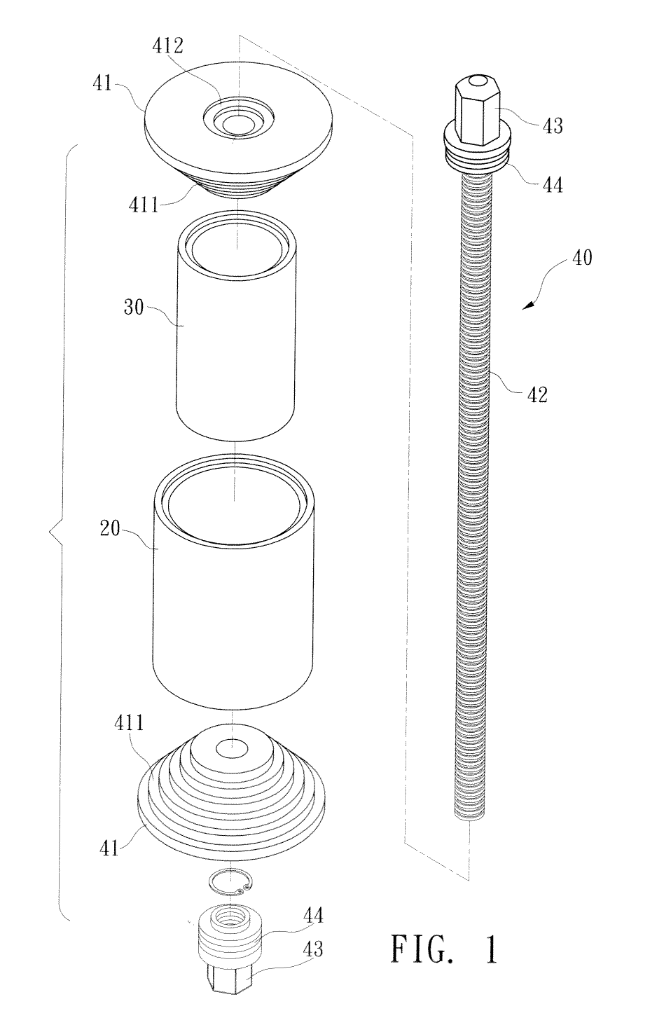

With reference to FIGS. 1 to 3 for a structure of a preferred embodiment of the present invention, the figures are provided for the illustration purpose only, but not intended for limiting the scope of the present invention.

The present invention provides a bearing mounting and dismounting tool for dismounting a bearing 10 from a mounting hole 51 of a mechanical component 50 or mounting the bearing 10 onto the mounting hole 51 of the mechanical component 50. The bearing mounting and dismounting tool comprises a first pipe 20, a second pipe 30 and an operating module 40.

The first pipe 20 is a circular pipe with an appropriate length, and an end of the first pipe 20 can be abutted against a peripheral wall of the mounting hole 51 of the mechanical component 50 installed with the bearing 10. More specifically, the internal diameter of the first pipe 20 should be greater than the external diameter of the bearing 10 to prevent the first pipe 20 from being contacted with a distal surface of the bearing 10, and the external diameter of the first pipe 20 should be greater than the hole diameter of mounting hole 51 to provide a force applying position to abut against the peripheral wall of the mounting hole 51.

The second pipe 30 is also a circular pipe with an appropriate length, and coaxially aligned with the first pipe 20, and an end of the second pipe 30 is abutted against a distal surface of the bearing 10. More specifically, the external diameter of the second pipe 30 should be smaller than the internal diameter of the first pipe 20 to allow the second pipe 30 to passed into the first pipe 20, and an end of the second pipe 30 can be abutted against the distal surface of the bearing 10 to constitute a contact position with the bearing 10.

The operating module 40 includes two disc 41 abutted against opposite ends of the first and second pipes 20, 30 respectively, and the two discs 41 include a plurality of abutting surfaces 411 with different widths and in a continuous stairway shape disposed in the same direction on the distal surface of the corresponding pipes, and an embedding slot 412 concavely formed on another distal surface of each of the two discs 41, and a screw rod 42 is coaxially passed into the first and second pipes 20, 30, and both ends of the screw rod 42 are passed out from the two discs 41 respectively, and two screw thread inserts 43 are screwed onto both ends of the screw rod 42 respectively, and each screw thread insert 43 further includes a top compressing element 44 sheathed on the screw thread insert 43 and embeddable into the embedding slot 412 of the corresponding disc 41, and each screw thread insert 43 can be rotated to drive the top compressing element 44 to push the disc 41 to move along the axial direction of the screw rod 42, and push the first and second pipes 20, 30 to change their relative positions.

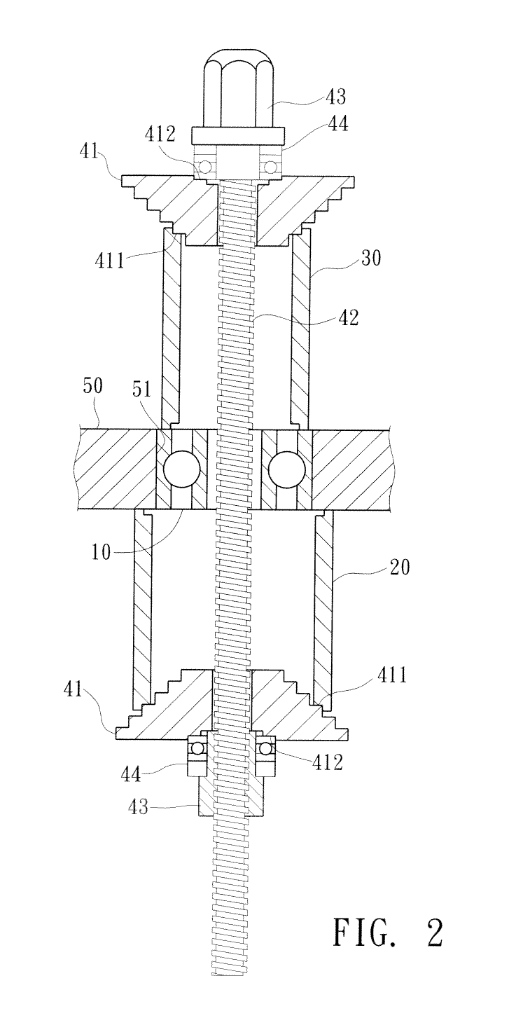

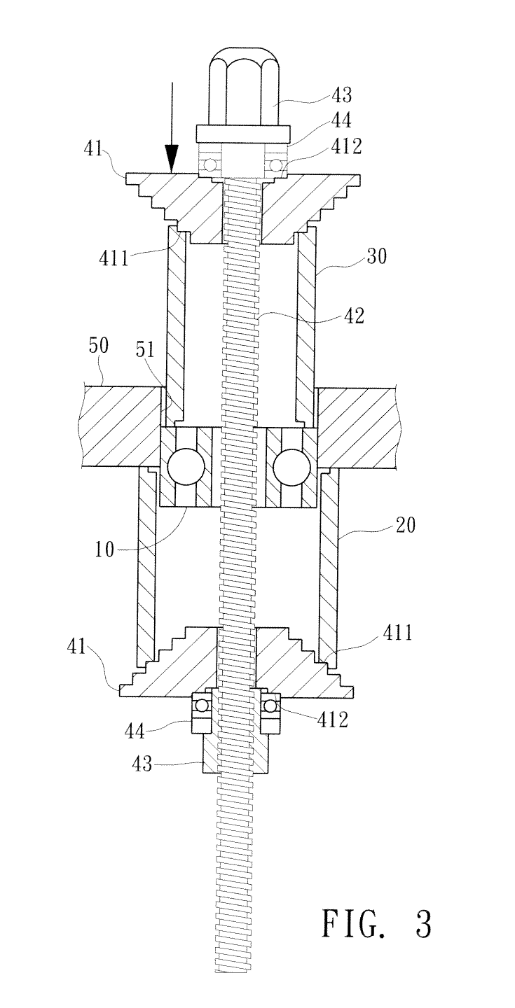

With reference to FIGS. 2 and 3 for the applications of the bearing mounting and dismounting tool in accordance with the present invention, the first pipe 20 is abutted against the peripheral wall of the mounting hole 51 of the mechanical component 50 installed with the bearing 10, and the second pipe 30 is abutted from another side against the distal surface of the bearing 10 in the mounting hole 51, such that the first and second pipes 20, 30 are clamped by both sides of the mounting hole 51 of the mechanical component 50 (as shown in FIG. 2), such that when an external force is applied to screw and rotate the screw thread insert 43 abutted against the disc 41 of the second pipe 30, the disc 41 on the second pipe 30 can push the second pipe 30 to move towards the first pipe 20 while pressing the bearing 10 to move towards the first pipe 20 at the same time, so as to achieve the effect of dismounting the bearing 10 (as shown in FIG. 3).

Similarly, the aforementioned method can be used for mounting the bearing 10 into the mechanical component 50 of the mounting hole 51, so as to achieve the effect of mounting the bearing 10.

It is noteworthy to point out that the size of the first and second pipes 20, 30 in accordance with this preferred embodiment can be changed according to the size of the bearing, and the disc having the plurality of abutting surfaces and in the continuous stairway shape and abutted against the end of the corresponding pipe is actually designed according to such size, so that the disc 41 also can be designed according to the size of the first and second pipes.

While the invention has been described by device of specific embodiments, numerous modifications and variations such as an increased quantity of the pipes, a different way of connecting the pipes in series could be made thereto by those generally skilled in the art without departing from the scope and spirit of the invention set forth in the claims.

What is claimed is:

1. A bearing mounting and dismounting tool, for mounting or dismounting a bearing in a mounting hole of a mechanical component, and the bearing mounting and dismounting tool comprising:
a first pipe, having an internal diameter greater than an external diameter of the bearing, and an external diameter of the first pipe greater than a hole diameter of the mounting hole;
a second pipe, coaxially aligned with the first pipe, and having an external diameter smaller than an internal diameter of the first pipe, and the second pipe being abuttable against a distal surface of the bearing;
an operating module, having two discs abutted against the first and second pipes respectively, and the two discs having a plurality of abutting surfaces with different widths and in a continuous stairway shape disposed at positions abutted against the distal surfaces of the corresponding pipes, and a screw rod being coaxially passed through the first and second pipes, and both ends of the screw rod being passed through and out from the discs respectively, and both ends of the screw rod passed out from the discs being screwed with a screw thread insert abuttable against the two discs to move the first and second pipes;
such that the first pipe can be abutted against a peripheral wall of the mounting hole of the mechanical component installed with the bearing, and the second pipe can be abutted from another side against the distal surface of the bearing in the mounting hole, and the screw thread insert of the operating module can be rotated to change the relative positions of the first and second pipes to mount or dismount the bearing.

2. The bearing mounting and dismounting tool of claim 1, further comprising a top compressing element sheathed on each screw thread insert and embeddable onto the distal surface of the corresponding disc.

3. The bearing mounting and dismounting tool of claim 2, wherein each disc includes an embedding slot concavely disposed at a distal surface of each top compressing element for accommodating the corresponding top compressing element.
